(19) United States
(12) Patent Application Publication
(10) Pub. No.: US 2011/0220150 A1
(43) Pub. Date: Sep. 15, 2011

(54) CONE NUT INSIDE DIAMETER CLEANING

(75) Inventor: Daryl Villa, Ridgeway, SC (US)

(73) Assignee: International Engine Intellectual Property Company, LLC, Warrenville, IL (US)

(21) Appl. No.: 13/018,461

(22) Filed: Feb. 1, 2011

Related U.S. Application Data
(60) Provisional application No. 61/312,210, filed on Mar. 9, 2010.

(51) Int. Cl. B08B 9/00; A46B 13/00

(52) U.S. Cl. 134/22.1; 15/3; 15/21.1

(57) ABSTRACT

A cleaning apparatus that includes a device carrier that holds a device, a guide plate that guides the device carrier during extraction or retraction, a carrier support that supports the device carrier, and a ramp that supports and guides the carrier support to a cleaning position.

### CROSS REFERENCE TO PRIOR APPLICATIONS

This application claims the benefit from U.S. Provisional Patent Application No. 61/312,210, filed on Mar. 9, 2010, the disclosure of which is hereby incorporated herein by reference for all purposes as if fully set forth herein.

### FIELD OF THE DISCLOSURE

This disclosure is directed to a method and an apparatus for cleaning a device or article, such as, for example, a cone nut.

### BACKGROUND OF THE DISCLOSURE

The process of remanufacturing devices, such as, for example, fuel injectors, generally involves time consuming and labor intensive disassembly and cleaning procedures. For example, a fuel injector may include a cone nut that must be cleaned before it can be used in the remanufacture device.

There exists an unfulfilled need for a method and an apparatus for effectively and efficiently cleaning device components such as, for example, cone nuts. The present disclosure provides a novel method and a novel apparatus that fulfill this unmet need.

### SUMMARY OF THE DISCLOSURE

According to an aspect of the disclosure, a cleaning apparatus is disclosed for cleaning a device. The cleaning apparatus comprises: a device carrier that holds a device; a guide plate that guides the device carrier during extraction or retraction; a carrier support that supports the device carrier; and a ramp that supports and guides the carrier support to a cleaning position. The apparatus may further comprise: a slide plate that secures the device in the device carrier; or a cleaner that engages and cleans an inner surface of the device. The device carrier may include a slot that is configured to hold the slide plate.

The guide plate may include a first channel that engages and guides a first roller located on the device carrier. The guide plate may include a second channel that engages and guides a second roller located on the device carrier.

The ramp may include a first ramp portion that guides a first roller to the cleaning position. The ramp may include a second ramp portion that guides a second roller to the cleaning position. The first and second rollers may be provided on the carrier support.

The cleaner may include a cleaning head that is configured to form a cleaning chamber with the device or a receptacle provided in the device carrier. The cleaning head may include a brush that is configured to engage an inner surface of the device. The cleaning head may further include a shaft that rotates the brush. The cleaning head may include another brush that is configured to engage another inner surface of the device. The other brush may have a diameter that is greater than a diameter of the brush.

According to another aspect of the disclosure, a cleaning apparatus is disclosed for cleaning devices, such as, for example, cone nuts, or the like. The apparatus comprises: a device carrier that holds a device; a carrier support that supports the device carrier; and a cleaner that engages the device to clean an inner surface of the device, wherein the carrier support is configured to move the device carrier to a cleaning position when the carrier support is substantially fully retracted in to the cleaning apparatus. The apparatus may further comprise: a guide plate that guides the device carrier during extraction or retraction; a ramp that supports and guides the carrier support to a cleaning position; or a slide plate that secures the device in the device carrier.

According to a further aspect of the disclosure, a method is disclosed for cleaning a device that has an inner surface. The method comprises: extracting a carrier support from a cleaning apparatus; extracting a device carrier from the cleaning apparatus; and loading a device in the device carrier, wherein the device carrier is moved away from a cleaning position when the carrier support is extracted from the cleaning apparatus. The method may further comprise extracting a slide plate. The method may further comprise: retracting the device carrier into the cleaning apparatus; and retracting the carrier support into the cleaning apparatus, wherein the device carrier is moved to the cleaning position by the carrier support when the carrier support is retracted into the cleaning apparatus. The method may also include actuating a cleaner to engage and clean the device.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a cross-section view of an example of a device;

FIG. 2 shows an example of a cleaning apparatus, which is constructed according to the principles of the disclosure, in a loading/unloading position;

FIG. 3 shows the cleaning apparatus of FIG. 2 with an example of a device carrier in a fully retracted, pre-cleaning position, according to the principles of the disclosure;

FIG. 4 shows the cleaning apparatus of FIG. 2 with the device carrier and a carrier support in a cleaning position, according to the principles of the disclosure;

FIG. 5 shows the cleaning apparatus of FIG. 2 with an example of a cleaner that may be lowered to engage and clean one or more devices loaded into the device carrier, according to the principles of the disclosure; and

FIG. 6 shows an example of a cleaning process for cleaning one more devices, according to the principles of the disclosure.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

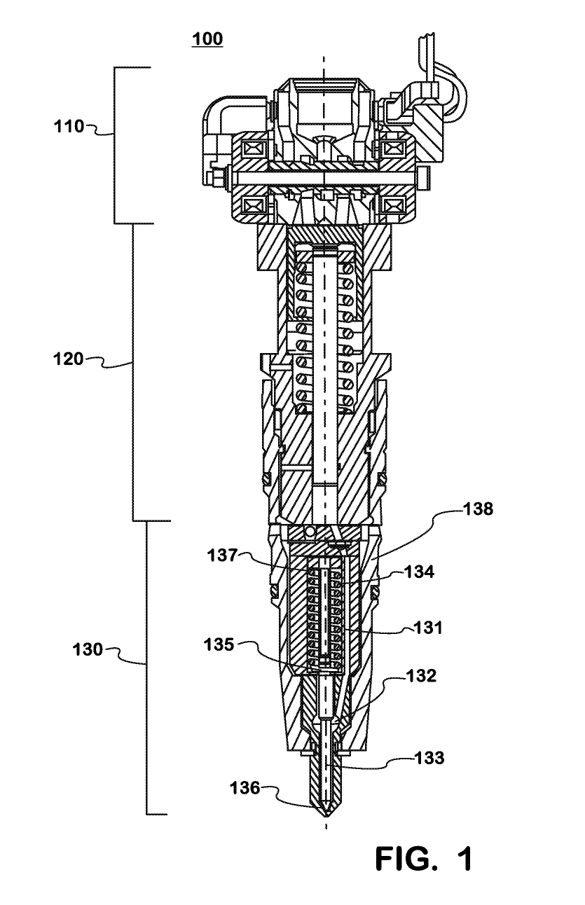

FIG. 1 shows a cross-section view of an example of a diesel fuel injector 100 that comprises a control valve body 110, an intensifier body 120, and a nozzle assembly 130. The intensifier body 120 may be attached to the control valve body 110 via any conventional mounting mechanism. The nozzle assembly 130 may include, for example, a fuel bore 131, a fuel chamber 132, a needle 133, a spring 134, a spring seat 135, and a spring cage 137, all of which may be housed in a cone nut 138. The spring 134 may be seated in the spring seat 135, which may be located in the spring cage 137. The needle 133, which includes an injection opening 136, may be elastically supported at one end (i.e., the end opposite the injection opening 136) by the spring 134. The cone nut 138 may encapsulate and hold the nozzle assembly 130, or the nozzle assembly 130 and intensifier body 120.

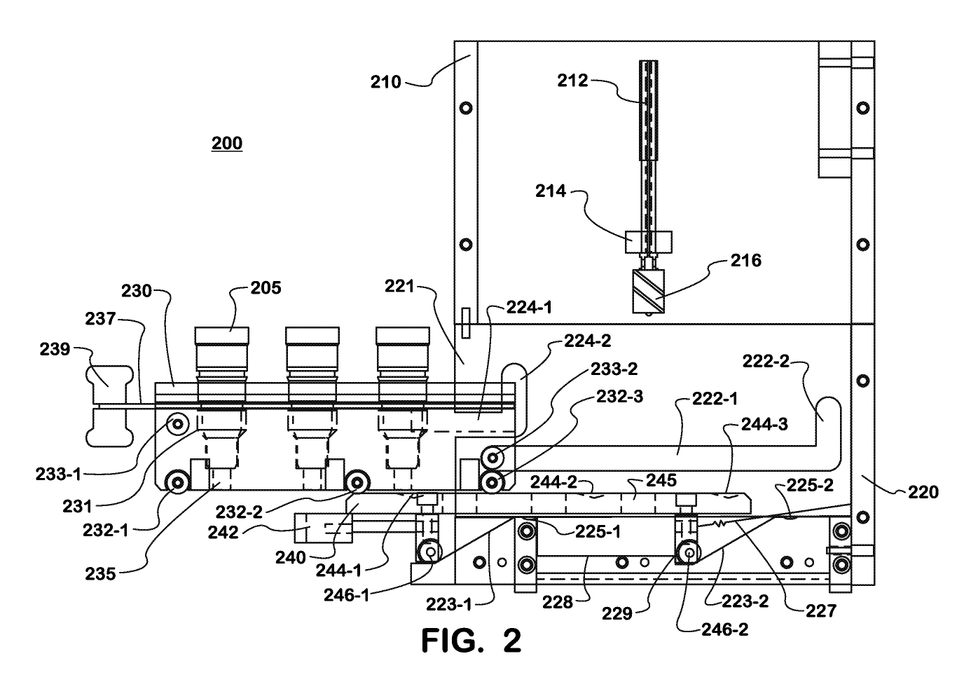

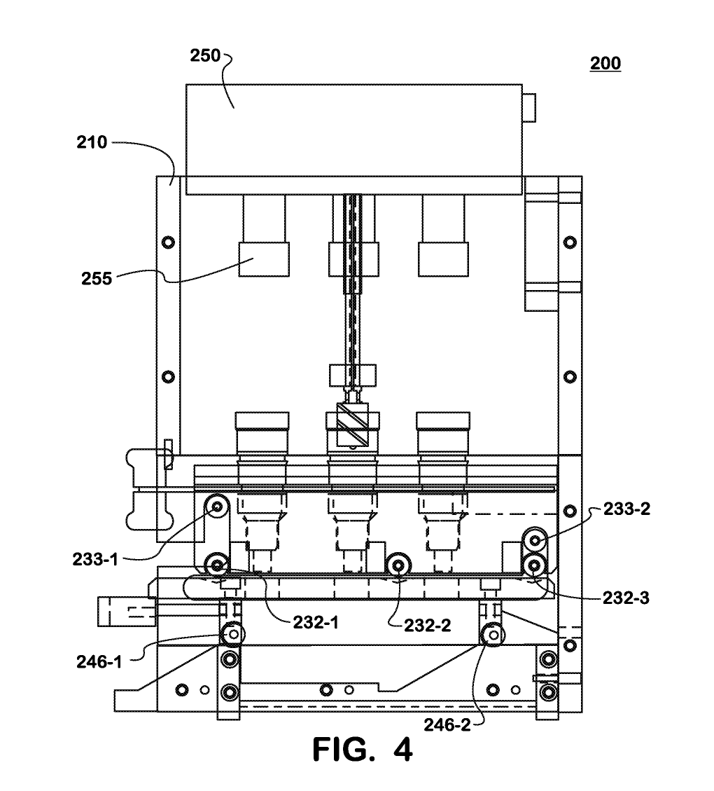

FIG. 2 shows an example of a cleaning apparatus 200 that is constructed according to the principles of the disclosure. The apparatus 200 comprises an upper housing portion 210, a lower housing portion 220, a device carrier 230, a carrier support 240, and a cleaner 250 (shown in FIG. 4). The apparatus 200 is configured to receive and clean one or more devices 205, which may include, for example, a fuel injector cone nut, or the like. In this regard, the apparatus 200 is configured to clean the inner surfaces of the devices 205, including the removal of, for example, carbon deposits, corrosion, adhesives, or other foreign materials.

The apparatus 200 may be manually driven or automatically driven. In the latter regard, the cleaning apparatus 200 may include a controller (not shown), a plurality of sensors (not shown), and one or more actuators (not shown) to drive the various parts of the apparatus 200, as will be understood by those having ordinary skill in the art from the following description. The controller may include a computer (not shown). The plurality of sensors may include, for example, position sensors for detecting the positions of the moving parts of the apparatus 200 (not shown). The actuator(s) may include, for example, a pneumatic actuator, an electric actuator, a motor, or the like, which may be configured to drive the moving parts of the apparatus 200.

The apparatus 200 is described hereinbelow with reference to components provided on one side (for example, the right side) of the apparatus 200 with the understanding that substantially the same components, or equivalents thereof, are provided on the other, opposite side (for example, the left side) of the apparatus 200.

The upper housing portion 210 may include one or more walls or panels to restrict access to an inner chamber defined by the upper housing portion 210. The upper housing may also include one or more guides (not shown) to guide the cleaner 250 as it moves up or down in the chamber with respect to the housing portion 210. The upper housing portion 210 may be affixed to the lower housing portion 220 by a plurality of fasteners (for example, a screw, a nut, a bolt, a rivet, a weld, or the like), or integrally formed with the lower housing portion 220.

The lower housing portion 220 may include a guide plate 221, a plurality of ramps 223, a carrier support stop 227, and a collector 228. The lower housing portion 220 may also include one or more walls or panels to restrict access to the inner chamber, which may be defined in part by the lower housing portion 220. The guide plate 221 may include a plurality of guides 222, 224 that are configured to engage and guide the device carrier 230 during extraction (or pulling) from the apparatus 200, or retraction (or pushing) into the apparatus 200. The guide 222 may include guide portions 222-1, 222-2, and the guide 224 may include guide portions 224-1, 224-2.

The ramps 223 may include a first ramp portion 223-1 and a second ramp portion 223-2. The ramps 223 are configured to support and guide the carrier support 240 as it is extracted (or pulled) from, or retracted (or pushed) into the lower housing 220. The ramp portions 223-1 and 223-2 may each have a setter 225-1, 225-2, respectively, for guiding the carrier support 240 to a cleaning position (shown in FIG. 4) and holding the carrier support 240 in that position. The setters 225-1, 225-2 may each include, for example, a recess, a stop, an indent, an opening, or the like, which is configured to receive and hold a respective roller 246-1, 246-2 when the carrier support 230 is fully retracted into the lower housing 220 and located in the cleaning position.

The carrier support stop 227 may be configured to limit the travel of the carrier support 240 during extraction (or pulling). The carrier support stop 227 may include, for example, a wire, a spring, or the like. The collector 228 is configured to collect the debris that may result from the cleaning process and to allow for easy collection of the debris for disposal. The collector 228 may include a stop 229 that may be configured to limit the travel of the roller(s) 246-2 when the carrier support 240 is extracted from the lower housing 220.

The carrier support 240 may include a plurality of setters 244 (for example, setters 244-1, 244-2, 244-3), a plurality of openings 245, and a plurality of rollers 246 (for example, rollers 246-1, 246-2). The carrier support 240 may further include a handle 242. The carrier support 240 is configured to be retracted (or pushed) into the lower housing portion 220 and guided into the cleaning position (shown in FIG. 4). The ramps 223 may guide and support the carrier support 240 as it is moved to (or from) the cleaning position. The setters 225-2, 225-2 may hold the rollers 246-1, 246-2, respectively, in the cleaning position after the carrier support 230 has been fully retracted in the lower housing 220, and prevent the carrier support 240 from moving from the cleaning position without an extracting (or pulling) force that is above a predetermined threshold. The plurality of openings 245 may be aligned with a corresponding plurality of receptacles in the device carrier 230. The openings 245 may be configured to allow debris to freely fall from a corresponding plurality of the devices 205 through the carrier support 240 and to the collector 228 to be collected and discarded.

The device carrier 230 may include a plurality of receptacles 231, a plurality of lower rollers 232 (for example, rollers 232-1, 232-2, 232-3), a plurality of upper rollers 233 (for example, 233-1, 233-2), a plurality of openings 235, and a slide plate 237. The device carrier 230 may further include a handle 239. Each of the receptacles 231 may be configured to receive and hold a device 205. The slide plate 237 may be configured to slide in a horizontal direction along the longitudinal axis of the device carrier 230 and to substantially simultaneously engage and lock all of the devices 205 with respect to the device carrier 230 when retracted (or pushed) into the device carrier 230, thereby restricting the devices 205 from moving in a horizontal plane—for example, a plane that is perpendicular to the surface of the page and substantially parallel to the longitudinal axis of the device carrier 230. The device carrier 230 may include a slot and a guide (not shown) for holding and guiding the slide plate 237 as it travels in to, or out from the device carrier 230.

The devices 205 may all be substantially the same or different from each other. The lower rollers 232 may be configured to roll on an upper surface of the carrier support 240. The lower rollers 232-2, 232-3 may be configured to remain atop of the carrier support 240 surface at substantially all times. The roller 233-2 may be located in the guide 222 at substantially all times. The roller 233-1 may be aligned with and configured to enter (or exit) the guide 224 when the device carrier 230 is retracted (or extracted) from the apparatus 200. The guides 222, 224 include vertical guide portions 222-2, 224-2, respectively, which are configured to guide the device carrier 230 in a vertical direction upward toward the upper housing 210, or downward away from the upper housing 210.

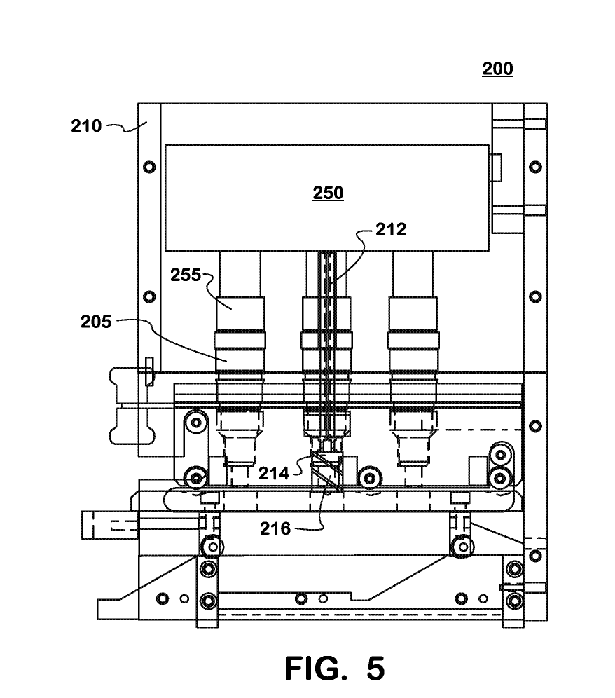

The cleaner 250 may include a plurality of cleaning heads 255 (shown in FIGS. 4 and 5). The cleaner 250 may move up or down along the guide(s) (not shown) in the upper housing 210 during the cleaning process, carrying with it the plurality of cleaning heads 255. Each of the cleaning heads 255 may include a shaft 212, an upper brush 214 and a lower brush 216. The lower brush 216 may have a smaller diameter than the upper brush 214. The cleaner 250 may include a plurality of rotary drivers (not shown), each of which is coupled to a corresponding shaft 212. The rotary drivers may be driven by a single motor through a plurality of gears (not shown), or a plurality of corresponding motors (not shown) that are provided in the cleaner 250. The cleaning heads 255 may be actuated and operated substantially simultaneously or individually, one at a time.

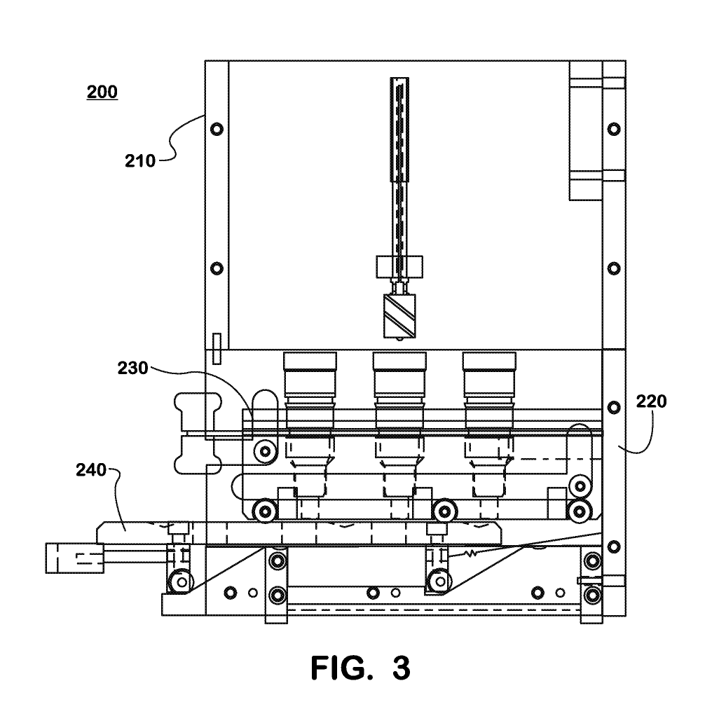

FIG. 3 shows an example of the apparatus 200 with the device carrier 230 substantially completely retracted (or pushed) in the lower housing 220 in a fully retracted, pre-cleaning position.

FIG. 4 shows the cleaning apparatus of FIG. 2 with the device carrier and a carrier support in a cleaning position, according to the principles of the disclosure;

FIG. 4 shows an example of the apparatus 200 with the device carrier 230 and the carrier support 240 substantially completely retracted in the lower housing 220 in a cleaning position. Also, the slide plate 237 is shown in the fully retracted, cleaning position. As seen, the device carrier 230 is supported by and lifted vertically by the carrier support 240 into the cleaning position. In this regard, the device carrier 230 is guided by the guide portions 222-2, 224-2 as it is lifted by the carrier support 240, which rises as it travels up the ramp portions 223-1, 223-2 during retraction. The device carrier 230 is lowered vertically by gravity as the carrier support 240 lowers, traveling down the ramp portions 223-1, 223-2 during extraction.

FIG. 5 shows an example of the apparatus 200 with the cleaner 250 lowered to engage the plurality of devices 205 that are provided in the device carrier 230, when the device carrier 230 and the carrier support 240 are located in the cleaning position. During cleaning, as seen in FIG. 5, the cleaning heads 255 may be lowered to completely engage the corresponding devices 205 (or receptacles 231) and to form cleaning chambers that are defined by the inner walls of the cleaning heads 255 and the inner surface walls of the devices 205 (or receptacles 231) to prevent debris from being ejected from the cleaning chambers when the brushes 214, 216 engage and clean the inner surfaces of the devices 205. Since the chambers are substantially closed, except for the openings 235 and 245, substantially all of the debris may fall through the openings 235, 245 to the collector 228.

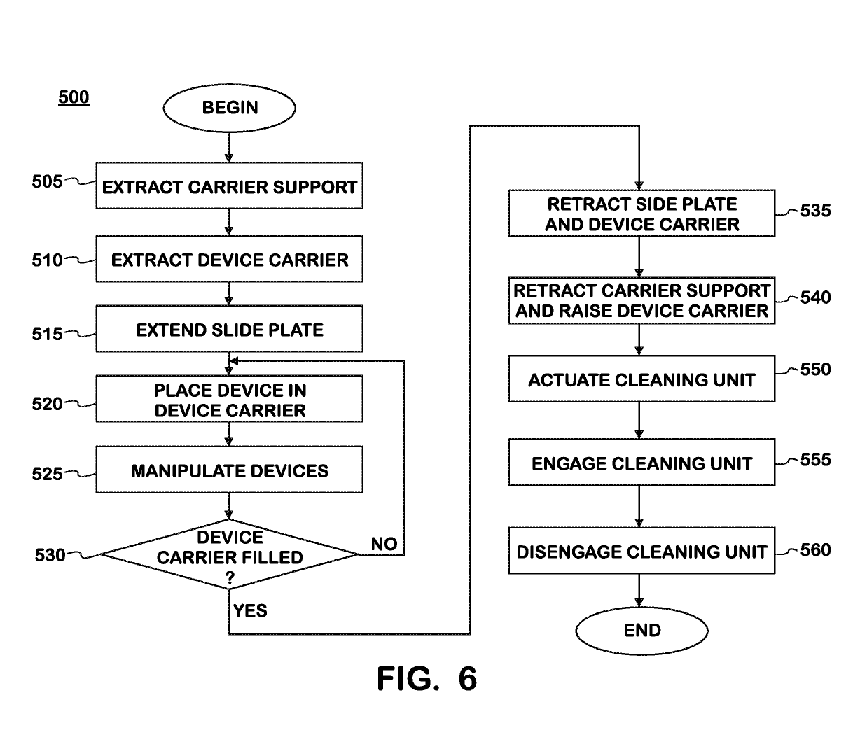

FIG. 6 shows an example of a cleaning process 500, according to the principles of the disclosure. Referring to FIGS. 2-6, the carrier support 240 may be extracted (or pulled) from the apparatus 200 (Step 505). When the carrier support 240 is extracted from the apparatus 200, the device carrier 230 may be lowered at substantially the same time by gravity. After the device carrier 230 has been lowered such that the roller 233-2 is in the guide portion 222-1 and the roller 233-1 is in the guide portion 224-1, the device carrier 230 may be extracted (or pulled) from the apparatus 200 (Step 510). The slide plate 237 may be extracted to unlock the receptacles 231 (Step 515). The devices 205 may be placed in the receptacles 231 (Step 520). The devices 205 may be placed in the receptacles one at a time, or substantially simultaneously. The devices 205 may be manipulated (for example, rotated, spun, wiggled, pressed, or the like) until the devices 205 are securely and fully positioned in the receptacles 231 (Step 525). The manipulation may be accomplished manually or automatically under the control of the controller (not shown). A determination may be made whether all of the receptacles 231 in the device carrier 230 have been filled (Step 530).

If it is determined that all of the receptacles 231 have been filled (YES at Step 530), then the slide plate 237 and device carrier 230 may be retracted into the apparatus (Step 535). It is noted that, if desired, the cleaning process 500 may continue even when fewer than all of the receptacles 231 have been filled. If it is determined that all of the receptacles 231 have not been filled (NO at Step 530), then the process 500 may wait until all of the receptacles 231 have been filled.

When the devices 205 have been loaded to the device carrier 230 and all of the devices 205 are in position and ready for cleaning, the device carrier 230 may be retracted (or pushed) into the apparatus 200 (Step 535). At substantially the same time, or at different times, the slide plate 237 may be retracted (or pushed) into the device carrier 230 to secure the devices 205 in their respective receptacles 231 (Step 535). Once the device carrier 230 is positioned in the pre-cleaning position (shown in FIG. 3), the carrier support 240 may be retracted into the apparatus 200 (Step 540). As the carrier support 240 is retracted into the apparatus 200, the device carrier 230 may be lifted by the carrier support 240 into the cleaning position (shown in FIG. 4).

After the device carrier 230, the carrier support 240 and the slide plate 237 are located in the cleaning position (shown in FIG. 4), the cleaner 250 may be actuated (Step 550). Alternatively, the cleaner 250 may remain actuated (ON) where a plurality of batches of the devices 205 are to be cleaned by the apparatus 200, such as, for example, in an assembly line cleaning process (not shown). The cleaner 250 may then be lowered together with the cleaning heads 255 to engage the plurality of devices 205 (Step 555). The rotating brushes 214, 216 may be lowered to engage and clean the inner surfaces of the devices 205. The brushes 216 may be lowered until, for example, the brush 216 reaches or passes the lowest point of the inner surfaces of the devices 205. The cleaner 250 may then be raised to disengage the plurality of devices 205 and the cleaning unit 250 may be turned OFF (Step 560). The carrier support 240 may then be extracted (Step 505), followed by extraction of the device carrier 230 (Step 510) and the slide plate 237 (Step 515) to allow for removal of the cleaned devices 205 from the device carrier 230.

According to an aspect of the disclosure, the cleaning process 500 may be automated and carried out under the control of the controller, including a computer, which may be provided in, for example, the cleaner 200. In this regard, a computer readable medium may be provided that includes a computer program that is tangibly embodied therein. The computer program may include a sequence of instructions for the computer, which may be embodied in the computer readable medium as sections (or segments) of code that, when executed in the controller, may cause some or all of the Steps 505 to 560 of the cleaning process 500 (shown in FIG. 6) to be carried out.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A cleaning apparatus, comprising:
a device carrier that holds a device;
a guide plate that guides the device carrier during extraction or retraction;
a carrier support that supports the device carrier; and
a ramp that supports and guides the carrier support to a cleaning position.

2. The apparatus according to claim 1, further comprising:
a slide plate that secures the device in the device carrier.

3. The apparatus according to claim 1, further comprising:
a cleaner that engages and cleans an inner surface of the device.

4. The apparatus according to claim 2, wherein the device carrier includes a slot that is configured to hold the slide plate.

5. The apparatus according to claim 3, wherein the cleaner comprises:
a cleaning head that is configured to form a cleaning chamber with the device or a receptacle provided in the device carrier.

6. The apparatus according to claim 5, wherein the cleaning head comprises:
a brush that is configured to engage an inner surface of the device.

7. The apparatus according to claim 6, wherein the cleaning head further comprises:
a shaft that rotates the brush.

8. The apparatus according to claim 5, wherein the cleaning head further comprises:
another brush that is configured to engage another inner surface of the device.

9. The apparatus according to claim 8, wherein said another brush has a diameter that is greater than a diameter of said brush.

10. The apparatus according to claim 1, wherein the guide plate comprises:
a first channel that engages and guides a first roller located on the device carrier.

11. The apparatus according to claim 10, wherein the guide plate further comprises:
a second channel that engages and guides a second roller located on the device carrier.

12. The apparatus according to claim 1, wherein the ramp comprises:
a first ramp portion that guides a first roller to the cleaning position; and
a second ramp portion that guides a second roller to the cleaning position,
wherein the first and second rollers are provided on the carrier support.

13. A cleaning apparatus, comprising:
a device carrier that holds a device;
a carrier support that supports the device carrier; and
a cleaner that engages the device to clean an inner surface of the device,
wherein the carrier support is configured to move the device carrier to a cleaning position when the carrier support is substantially fully retracted in to the cleaning apparatus.

14. The apparatus according to claim 13, the apparatus further comprising:
a guide plate that guides the device carrier during extraction or retraction.

15. The apparatus according to claim 13, the apparatus further comprising:
a ramp that supports and guides the carrier support to a cleaning position.

16. The apparatus according to claim 13, further comprising:
a slide plate that secures the device in the device carrier.

17. A method for cleaning a device that has an inner surface, the method comprising:
extracting a carrier support from a cleaning apparatus;
extracting a device carrier from the cleaning apparatus; and
loading a device in the device carrier,
wherein the device carrier is moved away from a cleaning position when the carrier support is extracted from the cleaning apparatus.

18. The method according to claim 17, further comprising:
extracting a slide plate.

19. The method according to claim 17, further comprising:
retracting the device carrier into the cleaning apparatus; and
retracting the carrier support into the cleaning apparatus,
wherein the device carrier is moved to the cleaning position by the carrier support when the carrier support is retracted into the cleaning apparatus.

20. The method according to claim 19, further comprising:
actuating a cleaner to engage and clean the device.
